(19) United States
(12) Patent Application Publication
(10) Pub. No.: US 2006/0178249 A1
(43) Pub. Date: Aug. 10, 2006

(54) Disposable handkerchief-bag device

(76) Inventor: Eva Pastor Serra, Pedreguer (ES)

Correspondence Address: MERCHANT & GOULD PC, P.O. BOX 2903, MINNEAPOLIS, MN, 55402-0903, US

(21) Appl. No.: 10/541,335

(22) PCT Filed: Jun. 29, 2004
(86) PCT No.: PCT/ES04/00304

§ 371 Date: Feb. 8, 2006

(30) Foreign Application Priority Data
Dec. 20, 2003 (ES) P 2003-3078

(51) Int. Cl. B31B 3/00

(52) U.S. Cl. 493/162

(57) ABSTRACT

A disposable handkerchief-bag device (10), of those acquiring a regular shaped surface (13) by means of an unfolding motion, made of a flexible and absorbent material allowing its use for blowing one's nose, collecting or storing materials of a different nature, for protecting the respiratory tract and for temporarily reducing the amount of oxygen inhalation, characterized in that it comprises a folding system, the opening (11) of which allows access to the inside and the possibility of subsequent closing (12), which is configured with means (9) for facilitating the gripping of the bag with the fingers, said handkerchief-bag (10) being folded when it is not in use.

### FIELD OF THE INVENTION

The present invention relates to a disposable handkerchief-bag device that can be used in situations in which organic body substances or substances of another nature must be stored and no other classic device is available, such as a cloth or paper handkerchief, a cloth, a bag or the like.

Examples of such situations are first and foremost in the field of hygiene, blowing one's nose when one has a cold, receiving and storing molecules or drops when coughing, cleaning one's lips during a meal, storing substances resulting from performing personal hygiene, especially when traveling, such as in a vehicle, train or airplane, but also as protection against the forceful inhalation of polluted air in smog situations due to the greenhouse effect in large cities, or due to the risk of contagion with a flu virus, etc., but also for collecting materials or objects up to a certain size, weight and consistency depending on the material used for the handkerchief-bag; and, finally, any situation that requires immediately having a simple and inexpensive means available that allows hygienically, aesthetically and discretely performing the previously indicated functions.

The device of the invention can specifically be used to blow one's nose and to vomit, to withstand bleeding and to collect picnic remains, to protect oneself against an adverse weather situation and to store wastes up to a certain size. It can also be used to prevent inhaling oxygen in anxiety attacks, increasing carbon dioxide levels, by applying the device in bag form over the nose and mouth.

### BACKGROUND OF THE INVENTION

Until now only paper and also cloth handkerchiefs were known, generally of a planar and square shape, which are especially used for blowing one's nose. However, these handkerchiefs have very limited uses in terms of absorption and storage of organic materials, and rather impractical handling when used for other purposes, given that they lack finger grips and an appropriate shape for doing this.

British patent number 453,141 shows a handkerchief substitute formed from a sheet of deformable material which is subjected to a die-cutting operation so as to make M-shaped cuts, subsequent folding and gluing of the edges to form a bag useful as a handkerchief, mainly for holding mucous and saliva.

Therefore, there is a need for a handkerchief-bag device for collecting materials of a different nature and for protecting the health of the user that offers the advantages of a small size, the application of inexpensive materials, high material absorption and storage capacity, filtering of reliable air and practical handling. It is precisely in these aspects where the present invention intervenes.

### SUMMARY OF THE INVENTION

The device developed by this invention comprises a folding system, the opening of which allows access to the inside thereof and the possibility of subsequent closing, which is configured with means for facilitating the gripping of the bag with the fingers, said handkerchief-bag being folded when it is not in use.

According to an aspect of the invention, the folding system contains a planar and regular shape when it is not in use.

According to another aspect of the invention, the folding system contains an open side enabling its opening and bag formation.

According to a further aspect of the invention, the folding system contains at least two closed sides forming the outer and inner wall of the bag.

According to another further aspect of the invention, the folding system contains inner closure means.

According to another aspect of the invention, the folding system contains outer grip means.

According to another aspect of the invention, the inner means contain two tabs on the inner sides of the walls of the bag with one end fixed respectively on the side of the opening of the bag and the other ends being free, resulting from the folding system.

According to an aspect of the invention, the inner means contain an area for self-adhesive or for any other conventional closing means.

According to another aspect of the invention, the outer grip means are located along the two opposite closed sides which result from the folding system, and allow introducing two or more fingers for a secure grip.

According to another aspect of the invention, the shape of the bag is carried out by folding, partial folds with a union of the parts through sealing, gluing, molding, or by any other small-scale or industrial process.

According to another further aspect of the invention, the flexible, absorbent and filtering material is chosen from any cellulose material, such as paper, plastic or the like.

According to a further aspect of the invention, the handkerchief-bag has any shape selected from a square, rectangular, triangular, prismatic or cylindrical shape or the like.

### BRIEF DESCRIPTION OF THE DRAWINGS

The previously mentioned as well as other features and advantages of the invention will become clearer as a result of the following detailed description in relation to the attached schematic drawings, wherein:

FIG. 1 shows a square-shaped cellulose paper made of two superimposed layers,

FIG. 2 shows a diagonal axis on which a first fold is performed,

FIG. 3 shows how this fold is carried out,

FIG. 4 shows two opposite axes on which two folds of two partial triangular shapes are carried out,

FIG. 5 shows how these two folds are carried out, one of them towards the top side and the other one towards the bottom side of the cellulose paper,

FIG. 6 shows two opposite axes on which two folds of two partial triangular shapes are carried out,

FIG. 7 shows how these two folds are carried out, one of them towards the top side and the other one towards the bottom side of the cellulose paper,

FIG. 8 shows a transverse axis on which a fold of a partial triangular shape is carried out, one with the top layer towards the top side and the other one with the bottom layer towards the bottom side,

FIG. 9 shows how these two folds are carried out on the cellulose paper,

FIG. 10 shows a 180° rotation,

FIG. 11 shows a three-dimensional view of the folded cellulose paper with the grips inside,

FIG. 12 shows a first embodiment of the handkerchief-bag as a result of the previous folding steps from FIG. 1 to FIG. 11, and of a change of sides, the inner sides being outside, the same as the grips.

### DETAILED DESCRIPTION OF THE INVENTION

For the sake of simplicity in the explanation, the following description will be made in relation to the use of the device of the invention for blowing one's nose. However, this must not be interpreted as a limit to the invention, but as an illustration thereof by way of example since, as previously stated, this device can have many other applications.

First in reference to FIGS. 9 to 12 in the drawings, it can be seen that the handkerchief-bag device 10 of the invention comprises a folding system of a planar and regular prismatic triangular shape 13.

The folding system contains an open side 11 and at least two closed sides with outer grip means 9. Housed inside of said handkerchief-bag 10 are two inner closure means 12 on opposite inner walls.

These two tabs have one end fixed respectively on the side of the opening 11 of the bag, and the other free ends with an area for self-adhesive or for any other conventional closure possibility. The folding system can be carried out by means of folding. However, also within the scope of the invention would be to form the bag by means of partial folds with the union of the parts through sealing, gluing, molding or any other small-scale or industrial process.

As can be seen in FIG. 1, this embodiment is based on a folding system of two square and superimposed layers A and B of cellulose paper.

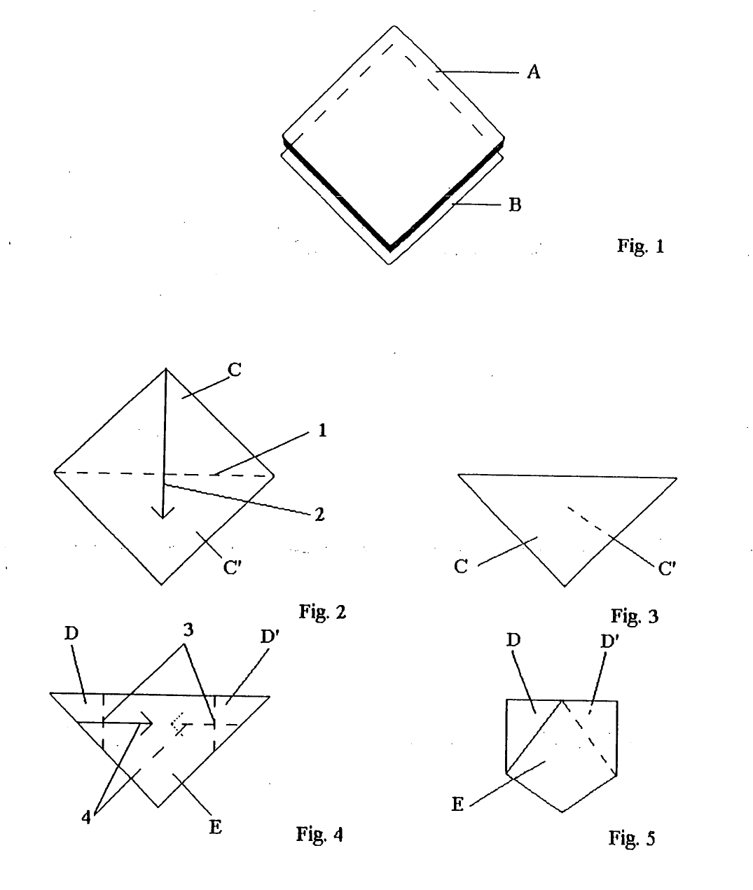

As shown in FIG. 2, in a first step the two layers of surface C are folded on the axis 1 in the direction 2 indicated on surface C′, resulting in what can be seen in FIG. 3.

As indicated in FIG. 4, surfaces D and D′ are folded along the axes 3 in the upwards and downwards directions 4, respectively. Shape E of FIG. 5 is obtained.

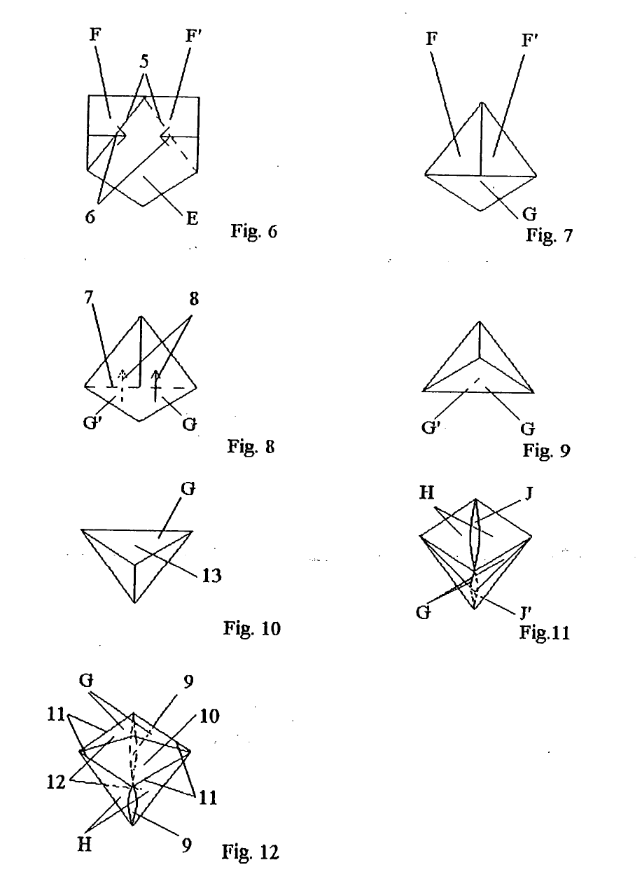

The folds of surfaces F and F′ along the axes 5 in the upwards and downwards directions 6, respectively, can be seen in the next step in FIG. 6.

A shape made up of partial surfaces F, F′ and G is obtained, as seen in FIG. 7.

FIG. 8 shows the folds to be folded after surface G along axis 7 in directions 8 with the top layer G upwards and the bottom layer G′ downwards.

A regular triangular shape 13 is obtained, as seen in FIG. 9, and a 180° can be seen in FIG. 10.

FIG. 11 shows a three-dimensional view of the open bag with the inner sides H and outer sides G which are interchanged in FIG. 12, sides H being outer sides and sides G being inner sides. The finger grips 9, which are inside in FIG. 9, are on the outside in FIG. 12. The inner closure means 12 remain inside the bag with their ends fixed on the opening sides 11 of the bag.

To use said device, the handkerchief-bag is opened by pulling on the edges of its open side 11 and introducing one or more fingers into each outer grip 9. Then the tabs are removed from the back inner closure means 12 and then the nose is blown inside the bag 10. Then the closure tabs 12 are closed through the self-adhesive thereof.

Once the device of the invention has performed its task, the handkerchief-bag assembly 10 and the contents thereof can be disposed of by throwing it into the garbage can or into any other waste collection container.

Although the previous description refers to the fact that the handkerchief-bag is of a prismatic triangular shape, this must not be interpreted as a limit to the invention since it would obviously be possible to construct said handkerchief-bag with other suitable shapes, for example square, cubical, circular, or cylindrical shapes, etc.

Obviously the use of the invention for tasks other than blowing one's nose would be carried out in the same manner as described above, that is, once the handkerchief-bag is unfolded, the fingers would be introduced into the grips, thus keeping the opening of the handkerchief-bag open, and the material which is to be stored is introduced inside, or the nose and mouth are covered for personal protection, after which time the device, and where applicable the contents thereof, would be disposed of in the most appropriate manner available.

The invention has thus created a device offering several advantages, among which the following can be pointed out:

Simple structure and as a result, ease in use.

Hygienic and practical use due to the two grips provided on the outside of the handkerchief-bag.

Use of inexpensive materials, such as cellulose paper, plastics, etc.

Single format, simplifying manufacture and reducing costs thereof.

Possibility of carrying it directly in any bag.

Aesthetic presentation, given that it does not take up more room than a sanitary napkin bag.

Possibility of selling it both in stores and in vending machines due to its size and packaging.

The previous description is focused on the essential features of the invention. However, it can be understood that the described device could be object of modifications in shape and structure without departing from the invention. Therefore, the intention is that the scope be limited solely by the contents of the attached claims.

1. A disposable handkerchief-bag device, of those acquiring a regular shaped surface by means of an unfolding motion, made of a flexible and absorbent material, formed from two square sheets (A, B) of said material arranged such that their vertexes coincide, wherein the device is obtained from a folding system, comprising:
folding of the superimposed sheets (A, B) on a diagonal fold line (1) such that one half (C) is folded over the other half (C′), resulting in an isosceles right-angled triangle,
folding of the two vertexes of the acute angles according to fold lines (3) parallel to the height of the isosceles right-angled triangle, equidistant between said height and said vertexes, one in the front portion and the other one in the back portion, obtaining a pentagon having two consecutive right angles,
folding of the vertexes of said right angles according to fold lines (6) spanning from the obtuse angles of the pentagon to the center of the common side of the two right angles, one in the front portion and the other one in the back portion,
folding of the right-angled triangles resulting after the first fold towards both sides along fold line (8) defining the limit of the last two folded triangles, and
turning the assembly inside out such that the inner portion becomes the outer portion and vice versa.

2. A device according to claim 1, wherein the folding system contains a planar and regular shape (13) when it is not in use.

3. A device according to claim 1, wherein the folding system contains a planar and regular shape (13) when it is not in use; and the folding system contains an open side (11), enabling its opening and bag formation.

4. A device according to claim 1, wherein the folding system contains a planar and regular shape (13) when it is not in use; and the folding system contains at least two closed sides forming the outer wall (H) and inner wall (G) of the bag.

5. A device according to claim 4, wherein the folding system contains inner closure means (12).

6. A device according to claim 5, wherein the folding system contains outer grip means (9).

7. A device according to claim 5, wherein the inner means (12) contain two tabs on the inner sides (G) of the walls of the bag with one end fixed respectively on the side of the opening (11) of the bag and the other ends being free resulting from the folding system.

8. A device according to claim 7, wherein the inner means (12) contain an area for self-adhesive or for any other conventional closure possibility.

9. A device according to claim 6, wherein the outer grip means (9) are located along the two opposite closed sides resulting from the folding system, and allow introducing two or more fingers for a secure grip.

10. A device according to claim 1, wherein the shape of the bag is carried out by means of folding, partial folds with a union of the parts through sealing, gluing, molding or any other small-scale or industrial process.

11. A device according to claim 1, wherein the flexible, absorbent and filtering material is chosen from any cellulose material, such as paper, plastic or the like.
